(19) United States
(12) Patent Application Publication
(10) Pub. No.: US 2010/0287350 A1
(43) Pub. Date: Nov. 11, 2010

(54) Exact Free Space Tracking for Region-Based Garbage Collection

(75) Inventor: Tatu J. Ylonen, Espoo (FI)

Correspondence Address: TATU YLONEN OY, LTD., KUTOJANTIE 3, ESPOO, 02630, FI

(73) Assignee: TATU YLONEN OY LTD, Espoo (FI)

(21) Appl. No.: 12/435,466

(22) Filed: May 5, 2009

(51) Int. Cl. G06F 12/02; G06F 12/00

(52) U.S. Cl. 711/165; 711/154; 711/E12.001; 711/E12.002

(57) ABSTRACT

A method for exactly tracking the amount of free space in an independently collectable memory region is described. This enables more accurate decisions about the utility of collecting each individual region. The method uses zombie multiobjects (special multiobject descriptors denoting inaccessible space) to track which inaccessible areas have already been added to a region's free space counters.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to garbage collection techniques for memory management in a data processing device.

### BACKGROUND OF THE INVENTION

Various garbage collection methods are described in the book R. Jones & R. Lins: Garbage Collection: Algorithms for Automatic Dynamic Memory Management, Wiley, 1996.

An example of a region-based garbage collector is provided in D. Detlefs et al: Garbage-First Garbage Collection, ISMM' 04, ACM, 2004, pp. 37-48. They use approximate tracking of free space. A much earlier example of a region-based garbage collector can be found in P. Bishop: Computer Systems with a Very Large Address Space and Garbage Collection, MIT/LCS/TR-178, MIT, 1977 (NTIS ADA040601). Bishop calls regions areas and the collection priority/utility is called gc_index.

The use of subordinate multiobjects for garbage collection is described in the co-owned U.S. patent application Ser. No. 12/432,779 by the same inventor, which is incorporated herein by reference.

In systems with very large memories using a global tracing algorithm (as in Detlefs et al) to estimate the utility of collecting each region may result in severely out-of-date information, as tracing hundreds of gigabytes may take a long time and cannot be performed very frequently. Similar considerations apply in mobile devices for power consumption reasons. Especially younger data structures may evolve very quickly, leading to grossly inaccurate estimates.

Inaccurate estimation of the gc_index (priority of collecting a region) results in wasted work and may lead to significant (temporary) memory leakage due to some regions with lots of free space not being collected as soon as possible. Accurate tracking of free space in each region would make the garbage collector more robust and more efficient.

### BRIEF SUMMARY OF THE INVENTION

The present invention adds exact tracking of free space in each region to multiobject-based garbage collection using subordinate multiobjects.

The basic idea is to have a field indicating the amount of unused (free) space in the descriptor data structure of each independently collectable memory region, and whenever a multiobject is freed or a section of a multiobject is rendered inaccessible by a write, add the number of new unused bytes (or cells) to this field.

However, it is common for writes to occur in a sequence such that the old values are successive nodes of a list (or tree). As the list (or tree) is linearized in a multiobject, the ranges of the subtrees rooted at the old values very significantly overlap. It is quite possible in such sequences to get estimates of freed space that approach N̂2 even if only N bytes are actually freed.

The solution is to add a new type of subordinate multiobject, called the zombie multiobject, to indicate space that has already been added to the number of unused bytes in the region.

There are two main cases where unused space is created:
freeing a top-level or detached subordinate multiobject, and
the old value of a written cell becoming inaccessible.

When freeing a top-level multiobject or a detached subordinate, the amount of space freed is essentially the size of the freed multiobject minus the sum of the sizes of all of its direct subordinates (assuming previously freed areas are indicated by zombie multiobjects). (No space becomes unused by freeing an attached subordinate, as its root has an implicit reference from the containing multiobject.)

As for the old value of a written cell, if it is not the root of a multiobject, that object and any other objects within the same top-level multiobject that are not within subordinate multiobjects become unused space. The unused space increases by the size of the subtree rooted at the old value minus the sum of the sizes of all direct subordinates of the multiobject containing the object pointed to by the old value in the range of the subtree. A zombie multiobject is created in this case for the address range of the subtree, and any subordinate multiobjects in that range are made direct subordinates of the zombie.

Whenever a zombie multiobject would be a direct subordinate of another zombie multiobject, they can be combined (essentially freeing the smaller zombie; this only results in preparenting its immediate subordinates, as the space indicated by zombies has already been freed and zombies have no exits and cannot have attached subordinates).

Depending on the embodiment, it may or may not be desirable to leave a zombie when freeing a top-level multiobject. In the preferred embodiment the subordinates of a freed top-level multiobject are simply promoted to top-level multiobjects (and direct zombie subordinates freed).

Whenever the amount of unused space in a region changes, its gc_index can be updated accordingly.

### BRIEF DESCRIPTION OF THE SEVERAL VIEWS OF THE DRAWING(S)

FIG. 1 illustrates a top-level multiobject with several subordinate multiobjects and a zombie multiobject.

FIG. 2 illustrates freeing a multiobject.

FIG. 3 illustrates processing the address range rooted at the old value of a written cell.

FIG. 4 illustrates a data processing device according to the an embodiment of the invention.

### DETAILED DESCRIPTION OF THE INVENTION

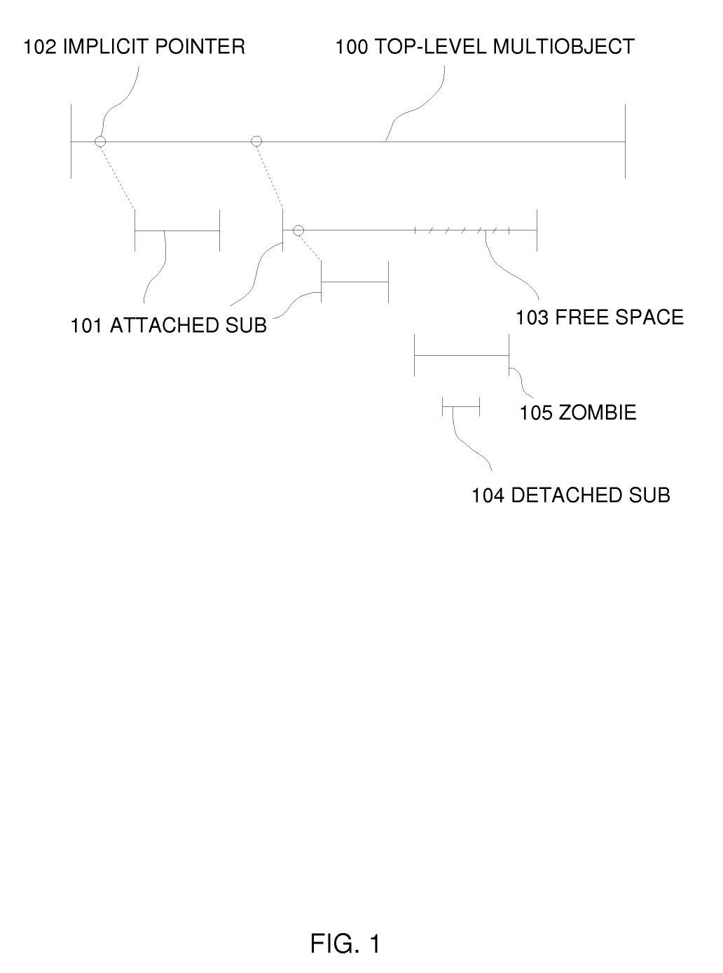

FIG. 1 illustrates a top-level multiobject with several subordinate multiobjects. In the figure, memory addresses run from left to right. (100) illustrates the address range of the top-level multiobject. (101) illustrate attached subordinate multiobjects. (102) illustrates an implicit pointer contained somewhere (exact position generally not known) in the containing multiobject, in this case the top-level multiobject. (103) illustrates space rendered inaccessible by a write to within the multiobject (somewhere outside the shaded area). (104) illustrates a detached subordinate multiobject contained within the inaccessible space (the detached subordinate is accessible if it is still referenced from some live multiobject; however, there is no implicit pointer to it). (105) illustrates a zombie multiobject whose address range equals the shaded free space range (103), representing space whose free space has already been considered in the region's unused space.

In the description below it is assumed that zombie multiobjects never have another zombie as an immediate subordinate. Such zombie chains should be eliminated by the zombie eliminator discussed below. However, one skilled in the art could also construct embodiments where such chains are allowed, without deviating from the spirit of the invention. In an actual implementation the zombie elimination might not be a separate step but might be implemented as additional cases in the flowcharts so that the redundant zombies are never created in the first place. Presenting their elimination as a separate step simplifies the description.

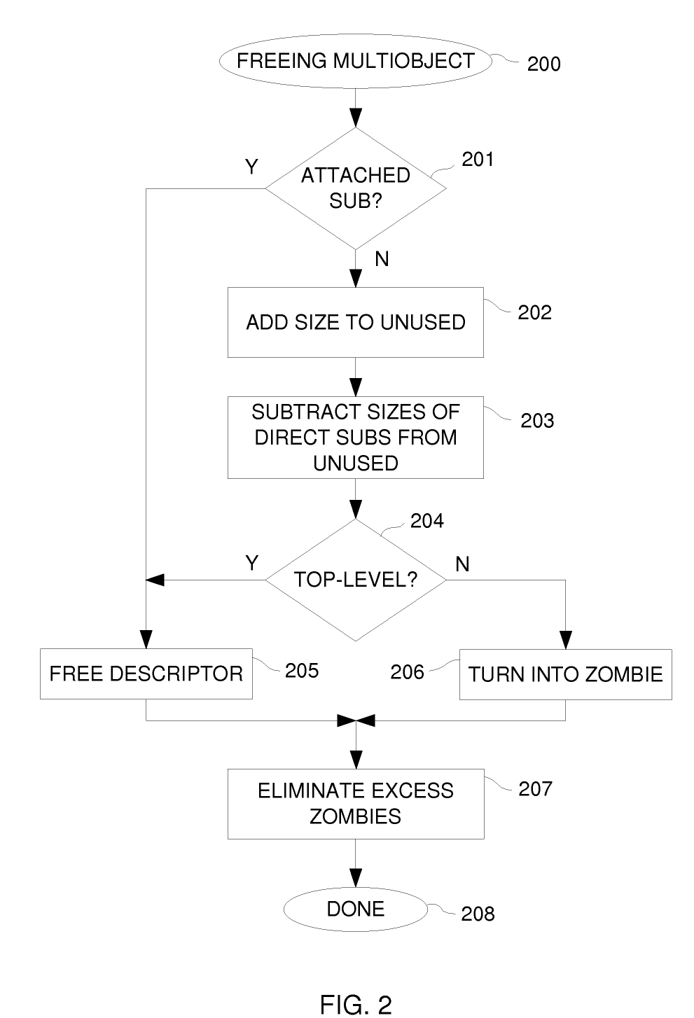

FIG. 2 illustrates freeing a multiobject by a free handler. Only additional steps relating to tracking unused space are shown; these steps would be combined with the steps for normal multiobject freeing, as described in the referenced earlier disclosure. These steps could go before, after, or interleaved with the other freeing related steps. (Freeing zombies is not shown here, as they are not explicitly freed in most embodiments.) The flow chart is shown assuming that no top-level zombies are created (some embodiments might want to create zombies also for top-level multiobjects).

The unused space tracking related freeing actions start at (200). At (201) it may be checked if the multiobject is an attached sub; no space is freed by freeing such multiobjects. At (202) the size of the multiobject being freed is added to unused space (size can be computed by subtracting the start address of its range from the end address of its range). At (203) the sizes of all of its direct subordinates (whether attached, detached, or zombie) are subtracted from the unused space (the addition/subtractions in steps (202) and (203) can be made either directly to the region's field, or to some local variable and finally adding the result to the region's field, or in some other suitable manner).

At (204) it is checked if the multiobject being freed is a top-level multiobject. If so, it is simply freed (its subordinates would usually be promoted before freeing it). At (206) the multiobject being freed is turned into a zombie (preferably by just changing its type field, but it is also possible to create a new multiobject descriptor and free the old one).

Step (207) illustrates eliminating redundant zombie multiobjects. A zombie multiobject is redundant if it is a direct subordinate of another zombie multiobject or if it is a top-level multiobject. (208) indicates the end of the unused space tracking actions.

One possible way of implementing redundant zombie elimination is to free any direct zombie subordinates after step (203).

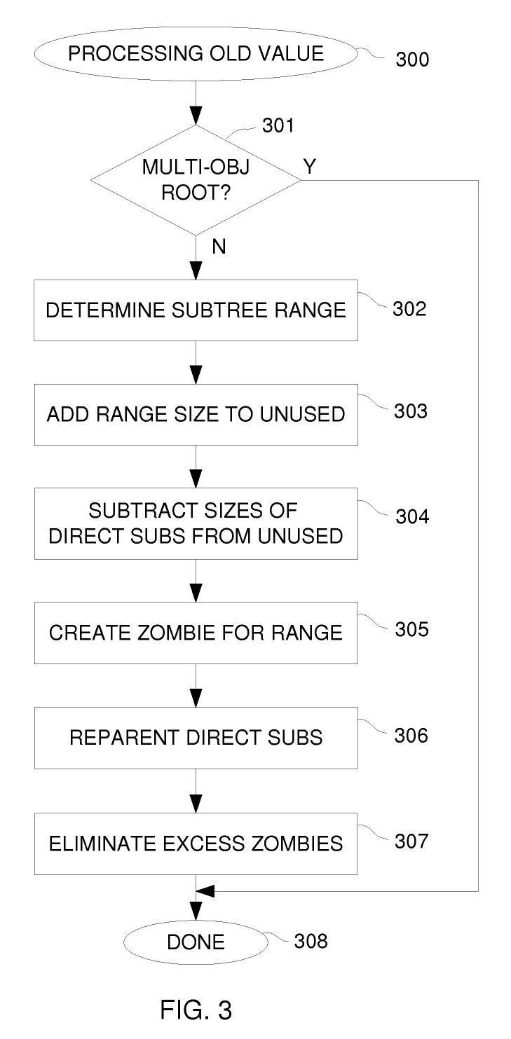

FIG. 3 illustrates processing the old value after a write (typically the written address and the old value are obtained from a write barrier buffer).

Processing the old value begins at (300). If the old value refers to a multiobject root at (301), then nothing needs to be done to update unused space (if the multiobject whose root it refers to is no longer reachable, then it will be freed separately later). Not shown in the figure is that if the old value does not contain a pointer to an object in the multiobject space, also then nothing needs to be done.

At (302) the address range of the subtree rooted at the object pointed to by the old value is determined (in many embodiments, the range as it was when the top-level multiobject was created). At (303) the size of the range is added to unused space. At (304) the sizes of all direct subordinate multiobjects of the multiobject within which the object at the old value is directly contained in the address range are subtracted from unused space. (The computation could also be done using a local variable, and then adding the final result to unused space.)

At (305) a new zombie multiobject is created for the address range. At (306) the direct subordinate multiobjects are preparented to be direct subordinates of the new zombie multiobject.

At (307) redundant zombies are eliminated. They could also be eliminated by freeing any direct zombie subordinates after step (304). At (308) the processing of the value is complete.

In some embodiments the write barrier buffer will deliver written addresses in random order. It is possible in some embodiments that the direct containing multiobject of the object pointed to by the old value is already a zombie. In that case the space freed by the latter write has already been counted as free by the write that created the parent zombie, and no unused space needs to be added.

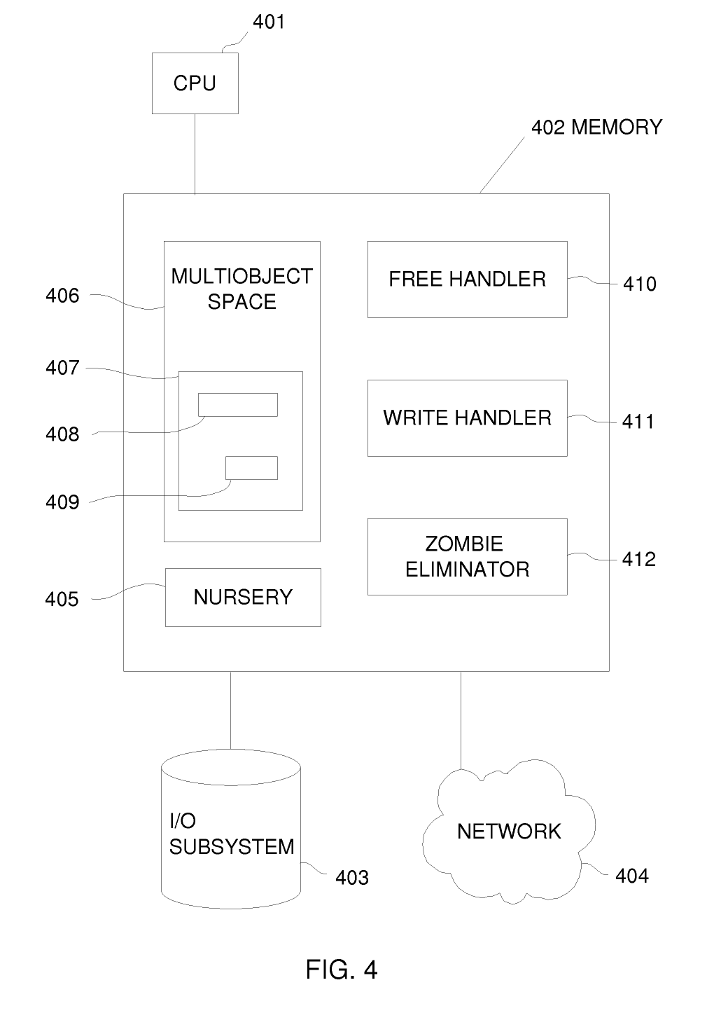

FIG. 4 illustrates a data processing device according to an embodiment of the invention. (401) represents one or more processors, (402) represents one or more memory devices, (403) represents an I/O subsystem (typically comprising non-volatile storage), (404) represents a communications network (such as Internet, cluster interconnect, or telephone network, possibly wireless). (405) illustrates one or more nursery memory areas where new objects are created. (406) illustrates one or more multiobject spaces comprising multiobjects (in the preferred embodiment no other data is stored in the multiobject space). (407) illustrates a top-level multiobject. (408) illustrates a zombie multiobject. (409) illustrates a detached subordinate multiobject. (410) illustrates a free handler for performing unused free space tracking; it is a component of the mechanism for freeing multiobjects. (411) illustrates a write handler, a component used for handling free space tracking when cells within existing multiobjects have been written. (412) illustrates a zombie eliminator, illustrating a component for eliminating redundant zombies (in many embodiments its functionality may be integrated into the free handler and write handler components).

An aspect of the present invention is a method of tracking unused space in a memory region in a data processing device comprising a free handler adapted to creating zombie multiobjects, the method comprising:
creating at least one zombie multiobject; and
using at least one zombie multiobject in tracking unused space in a memory region.

Another aspect of the present invention is a data processing device comprising:
a multiobject space; and
a free handler adapted to creating zombie multiobjects when multiobjects are freed from the multiobject space, and using at least one zombie multiobject in tracking unused space in at least one portion of the multiobject space.

A further aspect of the present invention is a computer program product operable to cause a data processing device to:
comprise a multiobject space;
comprise a free handler adapted to creating multiobjects; and
use at least one zombie multiobject in tracking unused space in at least one portion of the multiobject space.

Such a computer program product could be stored on a computer readable medium or transmitted as computer interpretable signals.

Even though the invention was described as using a count of unused space associated with each independently collectable region, it could equivalently be used with used space counts (essentially just swapping addition and subtraction; unused space basically equals region size minus used space). The granularity at which the counts are maintained could vary; they could equally well be at sub-region granularity or collectively for several regions. The counts need not be stored in the region's descriptor; they could be in separate memory locations associated with the regions (or whatever is the granularity of tracking; basically any portion of the multiobject space could be tracked individually). The counts may be in any appropriate units, such as bytes, words, cells, or object alignment units. Even though it was described that the sizes of all direct subordinate multiobjects be subtracted from the unused count, in some embodiments there could be multiobject types whose values should not be subtracted (e.g., special multiobjects describing popularity statistics for a particular object in anticipation of promoting it to be a popular object).

The exact semantics of zombie multiobjects could be varied by one skilled in the art, with corresponding changes in how the space used by subordinate multiobjects is taken into account. Even though multiobjects were described as forming a strict hierarchy, they could also be arranged on a linear axis (e.g., by memory addresses). As an alternative to having nested multiobjects, one could have discontiguous multiobjects, in which case a multiobject would be split if another multiobject was created within it. Such multiobjects could be merged when a multiobject between such parts is freed. Such approaches would still be essentially equivalent with the present invention.

Many variations of the present invention will be within reach of an ordinary person skilled in the art. Many of the steps in the methods could be rearranged, or operations grouped differently into components of a data processing device, without deviating from the spirit of the invention. When an element or step is mentioned in the claims, the intention is to mean that one or more such elements may be present. When multiple steps are listed, the intention is to say that the steps may take place in any order or possibly simultaneously, subject only to data flow constraints (i.e., the values used by a step must be available before they are used by the step). When a known computing method or algorithm is mentioned in the description or claims, the intention is that any known or future variant or known algorithm for solving the same problem can be used, any specific algorithm variant mentioned serving only as an example.

It is to be understood that the aspects and embodiments of the invention described herein may be used in any combination with each other. Several of the aspects and embodiments may be combined together to form a further embodiment of the invention. A method, a data processing device, or a computer program product which is an aspect of the invention may comprise any number of the embodiments or elements of the invention described herein.

What is claimed is:

1. A method of tracking unused space in a memory region in a data processing device comprising a free handler adapted to creating zombie multiobjects, the method comprising:
creating at least one zombie multiobject; and
using at least one zombie multiobject in tracking unused space in a memory region.

2. The method of claim 1, wherein a zombie multiobject indicates that any unused space in the address range of the zombie multiobject has already been counted in the region's unused space counts, except for space covered by the zombie multiobject's direct subordinate multiobjects.

3. The method of claim 1, further comprising:
adding the size of a freed multiobject to the unused count of the region containing the freed multiobject; and
subtracting the size of at least one direct subordinate multiobject of the freed multiobject from the unused count of the region containing the freed multiobject.

4. The method of claim 1, wherein at least one zombie multiobject is created by turning an existing multiobject into a zombie multiobject.

5. The method of claim 1, further comprising:
when creating a zombie multiobject, freeing any zombie multiobjects that would become direct subordinates of the new zombie multiobject.

6. The method of claim 1, further comprising:
when creating a zombie multiobject, checking if the new multiobject would be a direct subordinate of another zombie multiobject, and in such case refraining from creating the new zombie multiobject.

7. The method of claim 1, further comprising:
after creating a zombie multiobject, checking if there are any redundant zombie multiobjects, and freeing such redundant zombie multiobjects.

8. The method of claim 1, further comprising:
determining the address range of the subtree rooted at the object pointed to by the old value of a written cell; and
creating a zombie multiobject for the range.

9. The method of claim 8, further comprising:
adding the size of the range to unused space associated with the region containing the object; and
subtracting the size of at least one direct subordinate multiobject in the range from the unused space associated with the region containing the object.

10. The method of claim 8, further comprising:
preparenting at least one multiobject that is a direct subordinate of the multiobject directly containing the object to be a direct subordinate of the created zombie multiobject.

11. A data processing device comprising:
a multiobject space; and
a free handler adapted to creating zombie multiobjects when multiobjects are freed from the multiobject space, and using zombie multiobjects in tracking unused space in at least one portion of the multiobject space.

12. The data processing device of claim 11, further comprising a write handler.

13. The data processing device of claim 11, further comprising a zombie eliminator.

14. A computer program product operable to cause a data processing device to:
comprise a multiobject space;
comprise a free handler adapted to creating multiobjects; and
use at least one zombie multiobject in tracking unused space in at least one portion of the multiobject space.
